(19) United States
(12) Patent Application Publication
(10) Pub. No.: US 2022/0363974 A1
(43) Pub. Date: Nov. 17, 2022

(54) Oil Well Additive

(71) Applicant: James Matlock, Nacogdoches, TX (US)

(72) Inventor: James Matlock, Nacogdoches, TX (US)

(21) Appl. No.: 17/727,873

(22) Filed: Apr. 25, 2022

Related U.S. Application Data
(60) Provisional application No. 63/188,653, filed on May 14, 2021.

(51) Int. Cl. C09K 8/524; C09K 8/532

(52) U.S. Cl. CPC C09K 8/524; C09K 8/532; C09K 2208/20; C09K 2208/34

(57) ABSTRACT

An additive composition for a well fluid and method of use. The additive composition is formulated to remove contaminates, such as hydrogen sulfide, asphaltenes, and paraffins from well fluids and improve well yield during oil and gas recovery and production operations. The additive composition is also used to clean and lubricate oil production equipment associated with the oil and gas recovery and production operations. A drip system may be used to introduce the additive composition into an oil well, tank, or pipe. Alternatively, a processing tool may be used to inject and circulate the additive composition into a tank to precipitate solid waste, heavy metals, and oil out of the well fluid

### CROSS-REFERENCE TO RELATED APPLICATION

The present application claims priority to, and the benefit of, U.S. Provisional Application No. 63/188,653, which was filed on May 14, 2021, and is incorporated herein by reference in its entirety.

### FIELD OF THE INVENTION

The present invention generally relates to an additive composition for treating oil wells, and more specifically to an oil well treatment blend for reducing hydrogen sulfide emissions while increasing well yield. Accordingly, the present specification makes specific reference thereto. However, it is to be appreciated that aspects of the present invention are also equally amenable to other like applications, devices, and methods of manufacture.

### BACKGROUND

Hydrogen Sulfide (H2S) is a deadly, highly toxic gas often encountered in oil and gas fields around the world. It is a natural component of crude oil and natural gas that is typically a byproduct from the anaerobic bacterial decomposition of organic matter. Concentrations above 200 mg/m3 can result in instantaneous death. There has been a continual need in the oil and gas industry to develop processes that successfully remove hydrogen sulfide (H2S) to levels that assure safe production, transport, and storage of crude oil and natural gas.

Injuries and deaths due to H2S exposure have been unfortunately common in the oil and gas industry. Fugitive H2S gas emissions from failed oil and gas equipment has led to the deaths of many humans, livestock, and wildlife. This issue is further exacerbated by the fact that H2S is also a highly corrosive compound whose presence can lead to equipment failure and fugitive emissions.

In addition to the common issue of H2S, the presence of asphaltenes and paraffins in oil and gas formations can result in reduced production, well shut-in, equipment failure and other issues that result in billions of dollars lost each year. Paraffin, wax buildup, and other corrosion issues can cause damage to a well bore. Corrosion of a pipeline can lead to increase chasing of expensive pigs.

Accordingly, there is a great need for an oil well treatment blend for reducing contaminates while increasing well yield. There is also a need for a way to successfully decrease hydrogen sulfide to safe levels in oil production wells and pipelines. Similarly, there is a need for a way to successfully decrease the presence of asphaltenes and paraffins in oil and gas formations. Further, there is a need for a way of circulating the oil well treatment blend. There is also a need for a system to reduce and potentially eliminate any H2S, while forming a barrier and lubricating equipment.

In this manner, the improved chemical composition of the present invention accomplishes all of the forgoing objectives, thereby providing an easy solution for reducing H2S, asphaltenes and paraffins in oil and gas. A primary feature of the present invention is a multipurpose chemical blend for oil and gas companies, disposal operators, midstream companies, pipeline companies, refineries, and any industry with a contamination issue. The present invention is used in conjunction with a drip system and circulating tool and is injected into a well to clean corrosion, paraffin, and wax build up in the zone and the production string. Finally, the improved oil treatment system of the present invention is capable of clearing contaminates out of the water to make it ideal for recycling along with reducing wax and debris buildup.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an additive composition for removing a plurality of contaminates from a well fluid. The additive composition is formulated for use in oil and gas wells, saltwater disposal wells, oil and gas reclamation and recycling facilities, water recycling facilities, pipelines, and storage tanks. The additive composition is specifically formulated to reduce or eliminate the concentration of hydrogen sulfide, asphaltenes, and paraffins present in oil and gas formations. The additive composition is further formulated to lubricate and protect equipment used in the recovery, production, storage, and transportation of oil and gas.

The additive composition comprises a surfactant, a hydrogen sulfide scavenger, a tank cleaner, and a pipeline cleaner. The surfactant may be a surfactant, the hydrogen sulfide scavenger may be H2S EnviroScrub, the tank cleaner may be a Tank Cleaner, and the pipeline cleaner may be a Pipeline Cleaner. A preferred ratio of the additive composition is three parts of the surfactant, one part of the hydrogen sulfide scavenger, one part of the tank cleaner, and one part of the pipeline cleaner. The well fluid may any production fluid or waste fluid associated with an oil well or any water based fluid injected into an oil well for oil production.

In an additional embodiment, the subject matter disclosed and claimed herein comprises a method of treating a well fluid to remove a plurality of contaminates and increase well yield. The method comprises creating an additive composition for removing a plurality of contaminates from a well fluid. The additive composition is formulated for use in oil and gas wells, saltwater disposal wells, oil and gas reclamation and recycling facilities, water recycling facilities, pipelines, and storage tanks. The additive composition is specifically formulated to reduce or eliminate the concentration of hydrogen sulfide, asphaltenes, and paraffins present in oil and gas formations. The additive composition is further formulated to lubricate and protect equipment used in the recovery, production, storage, and transportation of oil and gas.

The additive composition comprises a surfactant, a hydrogen sulfide scavenger, a tank cleaner, and a pipeline cleaner. The surfactant may be a surfactant, the hydrogen sulfide scavenger may be H2S EnviroScrub, the tank cleaner may be a Tank Cleaner, and the pipeline cleaner may be a Pipeline Cleaner. A preferred ratio of the additive composition is three parts of the surfactant, one part of the hydrogen sulfide scavenger, one part of the tank cleaner, and one part of the pipeline cleaner. The well fluid may any production fluid or waste fluid associated with an oil well or any water based fluid injected into an oil well for oil production.

The method further comprises introducing the additive composition to the well fluid and allowing the additive composition to mix with the well fluid. The additive composition may be added all at once, or via a drip system depending on whether the additive composition is introduced directly into a well, or into a storage or transportation container. The method further comprises removing the plurality of contaminates once the well fluid after mixing.

In an additional embodiment, the subject matter disclosed and claimed herein comprises a method of treating a well fluid in a production tank to remove a plurality of contaminates. The additive composition is specifically formulated to reduce or eliminate the concentration of hydrogen sulfide, asphaltenes, and paraffins present in oil and gas formations. The additive composition is further formulated to lubricate and protect equipment used in the production tank.

The additive composition comprises a surfactant, a hydrogen sulfide scavenger, a tank cleaner, and a pipeline cleaner. The surfactant may be CTS surfactant, the hydrogen sulfide scavenger may be H2S EnviroScrub, the tank cleaner may be a Tank Cleaner, and the pipeline cleaner may be a Pipeline Cleaner. A preferred ratio of the additive composition is three parts of the surfactant, one part of the hydrogen sulfide scavenger, one part of the tank cleaner, and one part of the pipeline cleaner. The well fluid may any production fluid or waste fluid associated with an oil well or any water based fluid injected into an oil well for oil production.

The method further comprises using a processing tool to inject the additive composition into the production tank. The additive composition is injected at a plurality of depths simultaneously. The method further comprises using the processing tool to circulate and mix the additive composition with the well fluid. The method further comprises precipitating solid waste, heavy metals, and oil out of the well fluid.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The injection of H2S scavengers directly into production wells is a practice used to attempt to reduce hydrogen sulfide gas concentrations, thus preventing corrosion to equipment and promoting safe working conditions. There are two main types of hydrogen sulfide scavengers, a triazine based scavenger used for neutral to high pH conditions and an aldehyde based scavenger used for low pH conditions. An amine-based scavenger has also been developed and tested. Aldehyde based H2S scavengers are limited in the fact that they can cause formation damage.

Inhibitors and dispersants are used to minimize the impacts of asphaltenes. Paraffins are typically removed using mechanical removal and/or heat, which can lead to formation damage. Bacterial treatments, coating and insulating materials, cold flow, and electric and magnetic field or oscillatory motion are other methods that have not been fully investigated and/or proven at present. However, thinning agents using acetone and toluene have demonstrated some effectiveness in inhibiting wax deposition and buildup from paraffins in oil pipelines and production systems.

The present invention provides a chemical blend formulation that provides many benefits to oil and gas producers, midstream companies, and refineries. Producers can put the chemical blend formulation on a drip system that is injected into the well to clean the corrosion, paraffin, and wax build up in the zone and the production string. As the chemical blend moves to the surface with the oil, water, and natural gas, it will begin reducing or eliminating any H2S.

Once the formulation reaches separation equipment, it will also form an H2S barrier and lubricate the equipment. After being dumped from the separator into the tanks, the formulation will separate the oil from the water faster, thereby giving the producer a greater return on investment. The blend also clears many contaminates out of the water, thereby making it ideal for recycling. When injected and circulated, the blend reduces and potentially eliminates any H2S, while forming a barrier and lubricating equipment.

When the blend is injected into the pipeline or poured into a rail car, it cuts the paraffin and wax buildup, thereby reducing the expense associated with running a pig or washing out. When used in a disposal, the blend gives the disposal operator a greater return on skim oil, knocks out the contaminates in the water, and cleans out the well bore, thereby allowing the operator to run at maximum with a lower wellhead pressure.

One embodiment of the present invention comprises an additive composition. The additive composition is specifically formulated for removing a plurality of contaminates from a well fluid. The additive composition is formulated for use in oil and gas wells, saltwater disposal wells, oil and gas reclamation and recycling facilities, water recycling facilities, pipelines, and storage tanks. The additive composition is specifically formulated to reduce or eliminate the concentration of hydrogen sulfide, asphaltenes, and paraffins present in oil and gas formations. The additive composition is further formulated to lubricate and protect equipment used in the recovery, production, storage, and transportation of oil and gas.

The additive composition comprises a surfactant, a hydrogen sulfide scavenger, a tank cleaner, and a pipeline cleaner. In a preferred formulation, the surfactant may be a CTS surfactant, the hydrogen sulfide scavenger may be H2S EnviroScrub, the tank cleaner may be a Tank Cleaner, and the pipeline cleaner may be a Pipeline Cleaner. CTS surfactant is a preferred surfactant as it has been found experimentally to separate oil from waste faster than other surfactants tested. H2S EnviroScrub is a preferred H2S scavenger as testing has demonstrated that H2S EnviroScrub bonds with the other ingredients in the additive formulation better than other H2S scavengers. H2S envioroscrub is an organic formulation designed to remove H2S from gas and liquid. H2S EnviroScrub reacts with H2S to form stable, water soluble reaction products and also offers instant results and helps change the pH of the fluid being treated. A Tank Cleaner provides a bonding agent within the additive composition and helps precipitate the oil and solids out of the water or well fluid quicker. A Pipeline Cleaner acts as a cleaning agent for paraffin and other corrosive properties.

A preferred ratio of the additive composition is three parts of the surfactant, one part of the hydrogen sulfide scavenger, one part of the tank cleaner, and one part of the pipeline cleaner. The well fluid may any production fluid or waste fluid associated with an oil well or any water based fluid injected into an oil well for oil production. Examples of the well fluid may include oil and water mixtures; oil, water, and natural gas mixtures; effluents from an oil well; fracking fluids; contaminated wastewater mixtures; or any other fluids that would benefit from the removal of these contaminates.

In an additional embodiment, the subject matter disclosed and claimed herein comprises a method of treating a well fluid. The method is useful to remove a plurality of contaminates from the well fluid and increase well yield. The method comprises creating an additive composition for removing a plurality of contaminates from a well fluid. The additive composition is formulated for use in oil and gas wells, saltwater disposal wells, oil and gas reclamation and recycling facilities, water recycling facilities, pipelines, and storage tanks. The additive composition is specifically formulated to reduce or eliminate the concentration of hydrogen sulfide, asphaltenes, and paraffins present in oil and gas formations. The additive composition is further formulated to lubricate and protect equipment used in the recovery, production, storage, and transportation of oil and gas.

As discussed supra, the additive composition comprises a surfactant, a hydrogen sulfide scavenger, a tank cleaner, and a pipeline cleaner. In a preferred formulation, the surfactant may be CTS surfactant, the hydrogen sulfide scavenger may be H2S EnviroScrub, the tank cleaner may be A Tank Cleaner, and the pipeline cleaner may be A Pipeline Cleaner. A preferred ratio of the additive composition is three parts of the surfactant, one part of the hydrogen sulfide scavenger, one part of the tank cleaner, and one part of the pipeline cleaner. The well fluid may any production fluid or waste fluid associated with an oil well or any water based fluid injected into an oil well for oil production as discussed supra.

The method further comprises introducing the additive composition to the well fluid. Then the additive composition is mixed with the well fluid. The additive composition may be added all at once, or via a drip system depending on whether the additive composition is introduced directly into a well, or into a storage or transportation container. The method further comprises removing the plurality of contaminates once the well fluid after mixing. The method may further comprise allowing the additive composition to mix long enough to lubricate any oil well operating equipment and inhibit corrosion in a pipeline or storage tank used to retain or transport the well fluid.

In an example for use with a reclamation or recycling facility, the additive composition is preferably added to the wastewater at a ratio of one gallon per approximately 5,500 gallons of wastewater treated. This ratio is preferable to best reduce or eliminate basic sediment and water, paraffin, iron oxide, and other heavy metals. This is advantageous as junk oil is typically sold at a reduced price and the user will receive a better return on the oil, as it will be better in quality. The additive composition also reduces the threat of H2S injuries on location during the processing of the waste products.

In an example for use during production, the additive composition formulation reduces paraffin, asphaltenes, scale, and other corrosive properties that inhibit well production. An operator may employ a drip system to deliver approximately 1.5 gallons of the additive composition per day. This will allow for coating of the production string, removal of H2S, coating of the surface equipment, such as separators and tanks, and the treatment of tank batteries to keep the maximum amount of oil on location.

In an example for use with saltwater disposal, approximately 0.5 gallons of the additive composition may be added to the first tank up, per tank run, per day. This is advantageous as it creates more skim oil to capture, less basic sediment and water, lower wellhead pressure, and it reduces or eliminates the threat of H2S injuries to employees and others bringing waste to a disposal facility.

In an example for use with a water recycling facility, the additive composition will precipitate out the oil and heavy metals found in produced water. This precipitation makes the water easier to recycle for use in future completion jobs. By recycling the produced water, the operator will be reducing the need for surface and ground water; therefore, reducing their environmental footprint.

In an example for use with a pipeline, the additive composition treats the pipeline thereby decreasing corrosion in the system. The additive composition bonds with solids. This is advantageous as it keeps the pipeline running at capacity and reduced pressure. By keeping the inside of the pipeline lubricated, the life of the pipe is extended.

In an example for use with a storage tank, the additive composition treats the tank and its components thereby decreasing corrosion in the system. A preferred ratio for use with storage tanks is approximately a 1:5,500 ratio. The additive composition is formulated to reduce the buildup on the inside of the tanks; therefore, reducing the downtime for cleanout. The additive composition also reduces or eliminates the H2S threat to the employees and those living and working near the storage tanks.

In a specific example during a field test at a disposal, the disposal contained approximately 400 barrels of 36% basic sediment and water. The well fluid was circulated in the tank for three hours and allowed time to settle out This reduced the basic sediment and water to less than 4%. 50 barrels of waste were removed from the bottom of the disposal leaving approximately 350 barrels of quality oil for use. In addition to reducing the basic sediment and water by 89%, the iron oxide in the oil was reduced by 77%.

In an additional embodiment, the subject matter disclosed and claimed herein comprises a method of treating a well fluid in a production tank to remove a plurality of contaminates. The additive composition is specifically formulated to reduce or eliminate the concentration of hydrogen sulfide, asphaltenes, and paraffins present in oil and gas formations. The additive composition is further formulated to lubricate and protect equipment used in the production tank.

As discussed supra, the additive composition comprises a surfactant, a hydrogen sulfide scavenger, a tank cleaner, and a pipeline cleaner. The surfactant may be CTS surfactant, the hydrogen sulfide scavenger may be H2S EnviroScrub, the tank cleaner may be a Tank Cleaner, and the pipeline cleaner may be a Pipeline Cleaner. A preferred ratio of the additive composition is three parts of the surfactant, one part of the hydrogen sulfide scavenger, one part of the tank cleaner, and one part of the pipeline cleaner. The well fluid may any production fluid or waste fluid associated with an oil well or any water based fluid injected into an oil well for oil production.

The method further comprises using a processing tool to inject the additive composition into the production tank. The additive composition is injected at a plurality of depths into the production tank via a plurality of jets simultaneously. The method further comprises using the processing tool to circulate and mix the additive composition with the well fluid. The method further comprises precipitating solid waste, heavy metals, and oil out of the well fluid.

In an example for use with a production tank, the production tank may be an approximately 20 foot tall by 15 foot in diameter, 400 barrel production tank. The processing tool is connected to a port in the production tank positioned at approximately 19.5 feet from the bottom of the tank. The processing tool is positioned within the tank. The processing tool comprises a pipe with a plurality of jets, a first located at approximately two feet from the bottom at one end and a second approximately 1.5 feet from the top of the tool. The remaining jets are located at approximately 4 foot intervals.

This orientation changes the tank from a top dump to a gun-barrel dump. This allows for the capture of the force of the waste coming in from the separator to circulate the waste in the tank. In addition, a small pump may be connected to the line to circulate the waste within the tank. Circulation will help precipitate out the heavy metals and solid waste. It will also help precipitate more oil out of the water.

As routine experimentation has not produced preferred results in the past, a study was performed to determine an optimum ratio for a blend containing the four chemical additives used to eliminate or reduce the concentration of all three constituents of concern: H2S, asphaltenes, and paraffins. Four chemical additives: a triazine-based H2S inhibitor, a pipeline cleaner, an oil tank cleaner and a surfactant (used to stabilize the blend) were combined at ten various ratios. Each blend was placed in a laboratory-grade glass sample container that was stored at 4° C. until usage. Blends were prepared no more than 24 hours in advance of the experiment.

Experimentation was conducted under a vent hood for safety purposes. The effectiveness of the scavenger to remove H2S gas was evaluated using a water column based experiment. A 4 L Pyrex lab grade jar was prefilled with 1 L of produced crude oil and 1 L of deionized water and sealed with a double ported stopper. The oil/water mixture was continuously stirred at 800 rounds per minute (rpm) using a magnetic stir plate. A gas inlet located at the bottom of the jar was used to deliver 200 part per million (ppm) of H2S gas through the oil/water column of the jar. An H2S detector (Industrial Scientific, Tango TX1) measured H2S concentration in the headspace of the jar via tubing placed into the ported stopper located at the top of the 4 L jar. An additive blend was then introduced from a burette at a constant drip rate through a second port in the stopper to the liquid filled jar. H2S gas concentrations were measured continually as the additive blend was added for a period of five minutes. The final reading of H2S concentration in the jar headspace was then recorded and results were recorded in ppm H2S/mL min-1. The H2S gas was turned off and the headspace gas was allowed to elute through the fume hood for a period of 30 minutes. A sample of the supernatant was then collected, stored at 4° C., and then transported within 48 hours of sample collection to AnaLab, an accredited commercial laboratory, for the analysis of asphaltenes (using ATSM D3279-83) and paraffins (using TX 1005 Modified Method).

The experimental results are recorded in Table 1. Quantity of hydrogen sulfide loss (ppm/ml/min), asphaltene and paraffin concentration (mg/ml) upon introduction of additive blend to oil and water mixture.

TABLE 1

| | | H₂S Loss ^{†} | Asphaltenes | Paraffins |
|---|---|---|---|---|
| Sample ID | Ratio* | (ppm/mL/min) | (mg/mL) | (mg/mL) |
| 1 | 3:1:1:1 | 1.05 | ND <0.100 | ND <400 |
| Duplicate 1 | | | ND <0.100 | ND <400 |
| 2 | 6:2:1:1 | 0.14 | ND <0.100 | 556 |
| Duplicate 2 | | | ND <0.100 | 510 |
| 3 | 6:3:1:1 | 0.12 | 0.116 | 466 |
| Duplicate 3 | | | ND <100 | 649 |
| 4 | 3:1:1:2 | 0.19 | ND <100 | 249000 |
| Duplicate 4 | | | ND <100 | 318000 |
| 5 | 3:1:2:2 | 0.42 | ND <100 | 1970 |
| Duplicate 5 | | | ND <100 | 1980 |
| 6 | 3:1:1:3 | 0.32 | ND <100 | 431000 |
| Duplicate 6 | | | ND <100 | 430000 |
| 7 | 3:2:1:1 | 0.87 | ND <100 | ND <400 |
| Duplicate 7 | | | ND <100 | ND <400 |
| 8 | 6:3:2:2 | 0.8 | ND <100 | 423 |
| Duplicate 8 | | | ND <100 | 692 |
| 9 | 3:1:3:1 | 0.26 | ND <100 | 194000 |
| Duplicate 9 | | | ND <100 | 369000 |
| 10 | 1:1:1:1 | 0.39 | ND <100 | 297000 |
| Duplicate 10 | | | 0.122 | 315000 |
| Baseline Solution 1 | N/A | N/A | ND <100 | 357000 |
| Baseline Solution 2 | N/A | N/A | ND <100 | 406000 |
| Baseline Solution 3 | N/A | N/A | 0.119 | 286000 |

Notes:
1.) *Ratio = surfactant:scavenger:tank cleaner:pipeline cleaner
2.) ^{†} = H₂S measurement was not duplicated due to limited quantity of available H2S gas and length of trial period
3.) N/A = Not Applicable, Not Analyzed
4.) ND = Not Detected at given detection limit (e.g. <0.100)
5.) Baseline Solutions were samples taken from the oil/water solution mixture prior to additive or H2S gas introduction

The results from this experimentation indicate that a blend of 3 parts surfactant:1 part scavenger:1 part tank cleaner:1 part pipeline cleaner resulted in the maximum removal of H2S gas, asphaltenes and paraffins in the tested oil/water column experiment (Table 1). These results verify that the mixture (3:1:1:1) to control H2S, asphaltenes, and paraffins is the ideal mixture to reduce the concentration of these constituents in the gas and liquid phases, respectively.

This bench-top study indicates that a ratio of 3:1:1:1 is the best ratio of the chemical additives tested to control H2S, asphaltenes, and paraffins. However, there is limitation in the interpretation of the results for evaluating the elimination of asphaltenes due to the low initial concentration of this constituent in the provided produced oil sample.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An additive composition for removing a plurality of contaminates from a well fluid, the additive composition comprising:
a surfactant;
a hydrogen sulfide scavenger;
a tank cleaner; and
a pipeline cleaner.

2. The additive composition of claim 1, wherein the plurality of contaminates are hydrogen sulfide, asphaltenes, and paraffins.

3. The additive composition of claim 1, wherein the surfactant is CTS surfactant.

4. The additive composition of claim 1, wherein a ratio of the additive composition comprises three parts of the surfactant, one part of the hydrogen sulfide scavenger, one part of the tank cleaner, and one part of the pipeline cleaner.

5. The additive composition of claim 1, wherein the well fluid is an oil and water mixture.

6. The additive composition of claim 1, wherein the well fluid is an oil, water, and natural gas mixture.

7. The additive composition of claim 1, wherein the well fluid is an effluent from an oil well.

8. The additive composition of claim 1, wherein the well fluid is a fracking fluid.

9. The additive composition of claim 1, wherein the well fluid is a production fluid from an oil well.

10. A method of treating a well fluid to remove a plurality of contaminates and increase well yield, the method comprising the steps of:
creating an additive composition by combining a surfactant, a hydrogen sulfide scavenger, a tank cleaner, and a pipeline cleaner;
introducing the additive composition to the well fluid;
allowing the additive composition to mix with the well fluid; and
removing the plurality of contaminates from the well fluid.

11. The method of treating a well fluid of claim 10, wherein a ratio of the additive composition is three parts of the surfactant, one part of the hydrogen sulfide scavenger, one part of the tank cleaner, and one part of the pipeline cleaner.

12. The method of treating a well fluid of claim 10, wherein the additive composition is added to the well fluid at a ratio of one part of the additive composition to 5,500 parts of the well fluid.

13. The method of treating a well fluid of claim 10, wherein the additive composition is introduced into an oil well via a drip system at a rate of 1.5 gallons in a 24 hour period.

14. The method of treating a well fluid of claim 10 further comprising the step of allowing the additive composition to lubricate a plurality of oil well operating equipment.

15. The method of treating a well fluid of claim 10 further comprising the step of allowing the additive composition to inhibit corrosion in a pipeline or storage tank retaining the well fluid.

16. The method of treating a well fluid of claim 10, wherein the well fluid is a production fluid from an oil well.

17. The method of treating a well fluid of claim 10, wherein the surfactant is CTS surfactant.

18. The method of treating a well fluid of claim 10, wherein the tank cleaner is formulated to precipitate oil and solids from the well fluid.

19. The method of treating a well fluid of claim 10, wherein the plurality of contaminates are hydrogen sulfide, asphaltenes, and paraffins.

20. A method of treating a well fluid in a production tank to remove a plurality of contaminates, the method comprising the steps of:
combining three parts of a surfactant, one part of a hydrogen sulfide scavenger, one part of a tank cleaner, and one part of a pipeline cleaner to form an additive composition for treating the well fluid;
using a processing tool comprising a plurality of jets to inject the additive composition into the production tank at a plurality of depths simultaneously;
circulating the additive composition to mix with the well fluid with the processing tool; and
precipitating solid waste, heavy metals, and oil out of the well fluid.
